(19) United States
(12) Patent Application Publication
(10) Pub. No.: US 2024/0424612 A1
(43) Pub. Date: Dec. 26, 2024

(54) SPECIALIZED EXTRUSION FOR USE IN CONSTRUCTION

(71) Applicant: Pacific Coast Marine Windshields Inc., Vonore, TN (US)

(72) Inventors: Darren Bach, Delta (CA); Jeremiah Bach, Louden, TN (US)

(73) Assignee: Pacific Coast Marine Windshields Inc., Vonore, TN (US)

(21) Appl. No.: 18/752,489

(22) Filed: Jun. 24, 2024

Related U.S. Application Data
(60) Provisional application No. 63/510,038, filed on Jun. 23, 2023.

(51) Int. Cl. B23K 31/02; B23K 101/06; B23K 101/24; B23K 103/10; B63B 17/02

(52) U.S. Cl. CPC B23K 31/02; B63B 17/02; B23K 2101/06; B23K 2101/24; B23K 2103/10

(57) ABSTRACT

Devices, systems, and methods of crafting structures wherein the system is comprised of one or more receiver joints, one or more receiver extrusions, and one or more insertion extrusions, wherein the one or more receiver extrusions are comprised of a channel or aperture into which the one or more insertion extrusions are shaped to fit, and both extrusions are inserted, receiver extrusion first, into a receiver joint before being bound thereto.

### PRIORITY CLAIM

This application claims priority to and/or the benefit of U.S. provisional patent application Ser. No. 63/510,038 filed Jun. 23, 2023. The foregoing application is incorporated by reference in its entirety as if fully set forth herein.

### FIELD OF THE INVENTION

This invention relates generally to systems, devices, and methods for the assembly of extrusions for use in the construction of manufactured articles including, but not limited to, vehicles, structures, equipment, and goods.

### SUMMARY

This invention relates generally to systems, devices, and methods for the assembly of extrusions for use in the construction of manufactured articles including, but not limited to, vehicles, structures, equipment, and goods. Specific details of certain embodiments of the invention are set forth in the following description and in the figures to provide a thorough understanding of such embodiments. The present invention may have additional embodiments, may be practiced without one or more of the details described for any particular described embodiment, or may have any detail described for one particular embodiment practiced with any other detail described for another embodiment.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Traditional methods of manufacturing boat towers typically involve welding and/or mechanically fastening parts of said tower together in order to form the final product. Welding is a skill which must be learned over time and can be both a costly and time-consuming method of manufacturing. To mitigate some of this cost, the present invention discloses a form of joining of the parts in a manner such that a bonding agent is able to substantially coat the desired contact surfaces of the parts thereby adhering them together. The present invention can be used in place of, or in combination with, the existing method(s) in order to improve the final result. For some embodiments of the invention, it may also be practicable to utilize the traditional method of welding pieces together rather than utilizing the bonding agent, depending on the specific needs of the embodiment.

For some embodiments, the invention is comprised of a device for the assembly of components comprising: a receiver joint wherein the receiver joint is comprised of at least two apertures configured to receive at least one type of extrusion; and at least two types of extrusions, a receiver extrusion and an insertion extrusion, wherein; the receiver extrusion has a channel cut into at least one end of the receiver extrusion; and an insertion extrusion wherein the insertion extrusion is shaped to fit into the channel cut into the at least one end of the receiver extrusion.

The present invention allows for use of a bonding agent as a means, whether the primary or a secondary one, of attachment between said intersecting tubes and/or pipes or other components which can lead to quicker manufacturing and assembly of components of said boat tower, or such other component as needed by the specific embodiment in question. The present invention also reduces the likelihood of warping during the process that sometimes results from the welding, thus mitigating the likelihood of loss resulting from unsatisfactory final components. The present invention also makes use of specifically shaping the components to ensure that they are more easily able to interlock and reduce certain needs for precision when cutting or forming the parts, thereby reducing the time spent in production.

Some embodiments of the invention may be comprised of support structures for towers built on boats and/or ships. The disclosed invention may be embodied in the form of an extrusion profile usable as a means of mechanical intersection between elements of a boat tower's frame.

The present invention addresses issues related to the construction of towers for various watercraft, wherein the current method of construction of such towers is accomplished by extruding aluminum, then bending them and hand-cutting the ends of such extrusion to allow for a weld of the two sides together. This present method is extremely time, labor, and cost intensive, and requires skilled and talented personnel to achieve a desirable result. In addition, the welding process can often warp and distort the structure, resulting in an undesirable product. The present invention resolves many of these issues by removing and/or mitigating the need for welding while producing a product that is equally durable.

The extrusion component can take a variety of shapes and configurations. In some embodiments, the extrusion is comprised of substantially hollow polygonal shapes such as, but not limited to, box-tubes or cylindrical tubes, but could be similarly utilized in virtually any configuration of component, solid, hollow, porous, or otherwise. In some embodiments, the components and extrusions may take a variety of forms depending on the needs of the embodiment, or a combination of such forms, such as, but not limited to, solid pieces combined with box-tubes.

The extruded (even if solid or not specifically manufactured via extrusion) components of the invention may take a variety of forms. In some embodiments, the extrusions are aluminum, but in other embodiments, alternative metals or alloys could be used. Similarly, other embodiments may make use of other building materials such as, but not limited to, wood, composites, plastics, polymers, glass, hybrid materials, materials yet to be developed, and/or combinations of any of the foregoing.

While the present invention is described in terms of an embodiment for boat towers, it can be used in a variety of implementations including, but not limited to, on other types of vehicles, but can also be used in structure or equipment construction, or on other goods. For example, it could similarly be used to build towers on road vehicles or aircraft, or could be utilized for freestanding structures such as, but not limited to, towers. Some vehicles that could additionally benefit from the invention include, but are not limited to, trucks or service vehicles which may require towers or similar apparatuses to affix equipment to. Rescue vehicles which carry specialized equipment or have specific roles could use the present invention to strengthen towers or other frames upon them in order to better perform their role. Towers are however not the only use of the invention, and any structure wherein components need to be securely joined would benefit from the present disclosure. In embodiments where not all components need to be joined, such as embodiments with intrinsic connections, the invention can be utilized to join those components that require it, or to support other joining mechanisms.

The bonding agent can be a variety of substances capable of bonding with the other components of the invention. The present invention can also be utilized in addition to traditional welding or similar mechanisms and is not solely limited to replacing the welding component. For example, if ensuring a solid joining of parts is critical, the bonding agent method disclosed herein could be utilized to secure the surfaces of two components together, and then the components could be welded together to form a secondary bond. Some examples of bonding agents that can be used include bonding agents that involve the combination of two or more chemicals that cure when mixed; while other embodiments of the invention might use single chemical bonding agents. The exact bonding agent can vary, including, but not limited to, combinations of chemicals, epoxies, resins, cyanoacrylates, latex emulsions, or other forms of bonding agent. In some embodiments, combinations of agents may be used.

The invention may also be practiced with traditional forms of bonding, such as, but not limited to, welding, wherein the components, such as, but not limited to, the extrusions, may have channels cut into them at or near their ends so that one extrusion might fit into the channel of another, thereby allowing the extrusions to be bonded at those channels instead of having to specifically cut the ends of the extrusions to be able to bond together.

The present invention may incorporate channels, apertures, or other forms of pathway to permit the bonding agent to maximize coverage on the contact points preferred by a given embodiment of the invention, such are referred to as bonding grooves herein. Some embodiments may incorporate a porous material, rough surfaces, dimpled or otherwise textured surfaces, or specifically formed channels or apertures to improve the bond between the extrusion components and the applicable bonding agent. In some embodiments, there may be milled, lathed, or drilled channels, apertures, or other avenues for the bonding agent(s), or components of similar purpose, to reach interior or difficult-to-access areas of the extrusions or other components where joining is desirable. In some embodiments the channels, apertures, or other forms of avenue may be intrinsically constructed as part of the extrusion. Some embodiments may incorporate a combination thereof, such as, but not limited to, extrusions with a natural channel, where a secondary aperture is drilled, and the contact surfaces are intentionally abraded to create a rough, adherable surface for a bonding agent. Similarly, other embodiments of the invention may incorporate some or all of these techniques, along with others disclosed herein, such as, but not limited to, constructing the components in such a manner that they are assembled in a specific order to maximize bonding between the components. In some embodiments, the bonding grooves may be located on the receiver joint component that receives the other extrusions, while in other embodiments, bonding grooves may also be located on the other extrusions such as the receiver extrusion or insertion extrusion as described herein.

### BRIEF DESCRIPTION OF THE DRAWINGS

Embodiments of the present invention are described in detail below with reference to the following drawings:

FIG. 1 is a perspective view of a device for the assembly of components, in accordance with an embodiment of the invention;

FIG. 2 is a perspective view of an exploded form of a device for the assembly of components, in accordance with an embodiment of the invention;

FIG. 3 is a top view of a device for the assembly of components, in accordance with an embodiment of the invention;

FIG. 4 is a side view of a device for the assembly of components, in accordance with an embodiment of the invention;

FIG. 5 is a perspective view of a receiver joint component of a device for the assembly of components, in accordance with an embodiment of the invention;

FIG. 6 is a perspective view of a receiver extrusion component of a device for the assembly of components, in accordance with an embodiment of the invention;

FIG. 7 is a perspective view of a variant of a receiver extrusion component of a device for the assembly of components, in accordance with an embodiment of the invention;

FIG. 8 is a perspective view of an insertion component of a device for the assembly of components, in accordance with an embodiment of the invention;

FIG. 9 is a perspective view of a structure assembled using the device for the assembly of components, in accordance with an embodiment of the invention;

FIG. 10 is a perspective view of an exploded form of a structure assembled using the device for the assembly of components, in accordance with an embodiment of the invention;

FIG. 11 is a perspective view of the process of assembling a device for the assembly of components, in accordance with an embodiment of the invention; and

FIG. 12 is a perspective view of a structure assembled using the device for the assembly of components, in accordance with an embodiment of the invention.

### DETAILED DESCRIPTION

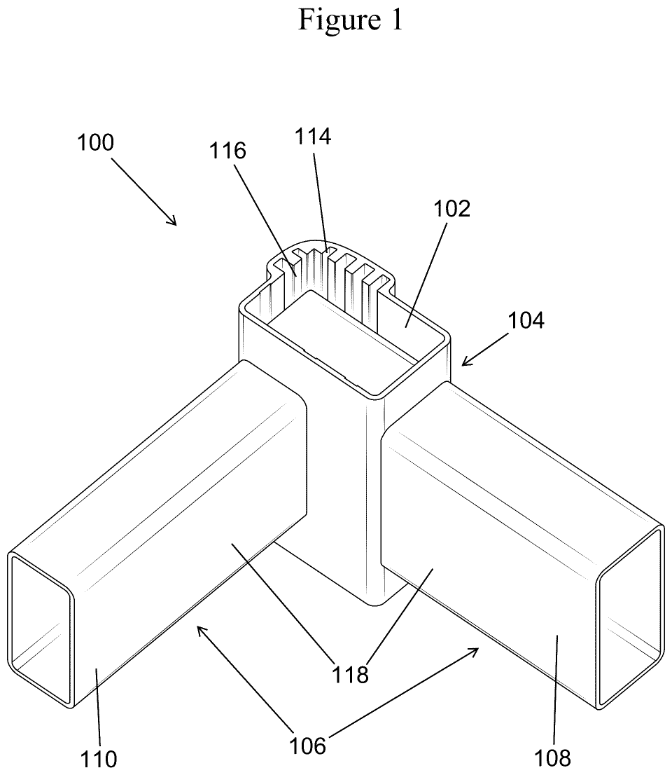

FIG. 1 is a perspective view of a device for the assembly of components, in accordance with an embodiment of the invention. In some embodiments, the invention is comprised of a device 100 for the assembly of components comprising: a receiver joint 102 wherein the receiver joint 102 is comprised of at least two apertures 104 configured to receive at least one type of extrusion 106; and at least two types of extrusions 106, a receiver extrusion 108 and an insertion extrusion 110, wherein the receiver extrusion 108 has a channel cut into at least one end of the receiver extrusion 108; and an insertion extrusion 110 wherein the insertion extrusion 110 is shaped to fit into the channel cut into the at least one end of the receiver extrusion 108. In some embodiments, the invention may be further comprised of one or more bonding grooves 114 on an inner surface 116 of the receiver joint 102. For some embodiments, the receiver extrusion 108 and insertion extrusion 110 may be bonded to the receiver joint 102 by welding or similarly bonding around the apertures 104 into which the receiver extrusion 108 and insertion extrusion 110 are inserted such that the aperture 104 is bonded to the outer faces 118 of the receiver extrusion 108 and insertion extrusion 110.

The receiver joint 102 can take a variety of forms and shapes; the variant depicted in FIG. 1 shows a receiver joint 102 configured to receive one of each extrusion type; a receiver extrusion 108 and an insertion extrusion 110. Typically, but not necessarily, the receiver joint 102 will be substantially hollow with an inner surface and outer surface, and configured to allow the receiver extrusion 108 and insertion extrusion 110 to intersect inside of the receiver joint 102. However, in other embodiments a receiver joint 102 may be configured to receive two or more of each type of joint. For example, a receiver joint 102 could be elongated and configured to receiver two receiver extrusions 108 where one is above the other and then two insertion extrusions 110 in a similar configuration. The receiver joint 102 can also be configured to have the extrusions 106 inserted, and thus emerge, at different angles; in some cases, the angle of insertion may be such that the extrusions 106 are perpendicular to the receiver joint 102, while in other cases they may emerge at an angle. In some embodiments, the extrusions 106 may be inserted and emerge at different angles relative to each other.

In some embodiments, the invention is a method for the assembly of components, the method comprising: forming a receiver joint 102 wherein the receiver joint 102 is comprised of at least two apertures 104 where each of the at least two apertures 104 is configured to receive at least one type of extrusion 106 and extrusions 106 inserted into each of the at least two apertures 104 would intersect at some point inside the at least two apertures 104; forming a receiver extrusion 108; cutting a channel into at least one end of the receiver extrusion 108; forming an insertion extrusion 110 shaped to fit into the channel of the receiver extrusion 108; inserting the receiver extrusion 108 into an aperture of the receiver joint 102; and inserting the insertion extrusion 110 into an aperture 104 of the receiver joint 102 such that it also inserts into the channel of the receiver extrusion 108.

In some embodiments, the receiver joint 102 has one or more bonding grooves 114 on at least one inner surface wherein the bonding grooves 114 may be comprised of the same material as the rest of the receiver joint 102, or may be comprised of a different material wherein the alternative material is applied to the receiver joint 102 or incorporated into it during construction. The one or more bonding grooves 114 may be modified to better bond with the extrusions, such as by frosting or adding texture to the grooves or other inner surfaces of the receiver joint 102, and/or by using a material that is porous. A bonding agent may then be applied to the one or more bonding grooves 114 prior to the insertion of the extrusions 106, such that the bonding agent adheres to the extrusions 106 once inserted and is capable of securing them inside the inner space of the receiver joint 102. In some embodiments, the bonding agent may not be used, and the extrusions 106 may be constructed such that once inserted into the receiver joint 102 they fit together in such a way that they are held mechanically and/or frictionally.

In some embodiments, the receiver joint 102 and extrusions may be joined through a welding method as well, which may be practiced in tandem with the bonding agent method described herein or separately. This approach would, for some embodiments, involve the process whereby the receiver extrusion 108 is first inserted into an appropriate aperture 104 of the receiver joint 102, followed by the insertion extrusion 110 being inserted into a second aperture 104 of the receiver joint 102 such that the insertion extrusion 110 and receiver extrusion 108 are both inside of the receiver joint 102. The user would then weld around the apertures 104 of the receiver joint 102, which would also weld the outward faces of the extrusions to such aperture. In some embodiments, the insertion extrusion 110 would have been inserted into the channel of the receiver extrusion 108, thereby helping ensure additional stability. In this way, the shape of the extrusion only needs to match the aperture 104, instead of the ends of the extrusions being cut to perfectly fit and contact the edge of the aperture 104, which saves time and cost.

Depending on the needs of the embodiment, the receiver joint 102 may not be configured with bonding grooves 114 and instead rely solely on the welding of the outer faces 118 of the extrusions 106 to the apertures 104 of the receiver joint 102. Alternatively, in some embodiments the bonding grooves 114 may have bonding agent applied to them in a variety of ways, such as, but not limited to, injection vertically relative to the extrusions 106 before, during, or after they are inserted, or a hole or orifice may be bored into the receiver joint 102 so that bonding agent may be injected into the bonding grooves 114. As an example, a hole may be bored in the receiver joint 102 from a reverse side of the inner surface 116 that the bonding grooves 114 are on, so bonding agent will enter into the receiver joint 102 and fill the bonding grooves 114. Depending on the embodiment, the bonding grooves 114 may also or alternatively be located on the receiver extrusion 108 and/or insertion extrusion 110.

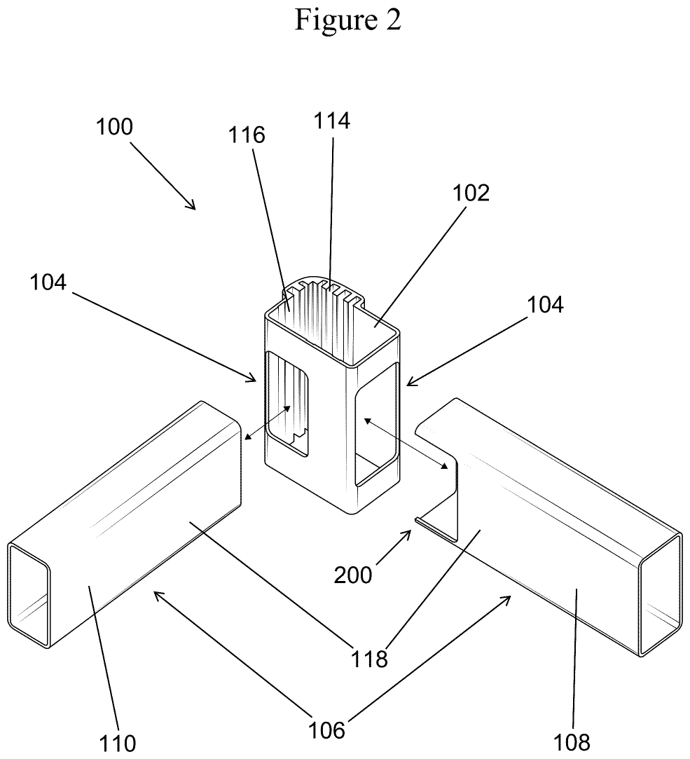

FIG. 2 is a perspective view of an exploded form of a device for the assembly of components, in accordance with an embodiment of the invention. In some embodiments, the invention is comprised of a device 100 for the assembly of components comprising: a receiver joint 102 wherein the receiver joint 102 is comprised of at least two apertures 104 configured to receive at least one type of extrusion; and at least two types of extrusions 106, a receiver extrusion 108 and an insertion extrusion 110, wherein the receiver extrusion 108 has a channel 200 cut into at least one end of the receiver extrusion 108; and an insertion extrusion 110 wherein the insertion extrusion 110 is shaped to fit into the channel 200 cut into the at least one end of the receiver extrusion 108. In some embodiments, the invention may be further comprised of one or more bonding grooves 114 on an inner surface 116 of the receiver joint 102. For some embodiments, the receiver extrusion 108 and insertion extrusion 110 may be bonded to the receiver joint 102 by welding or similarly bonding around the apertures 104 into which the receiver extrusion 108 and insertion extrusion 110 are inserted such that the aperture 104 is bonded to the outer faces 118 of the receiver extrusion 108 and insertion extrusion 110.

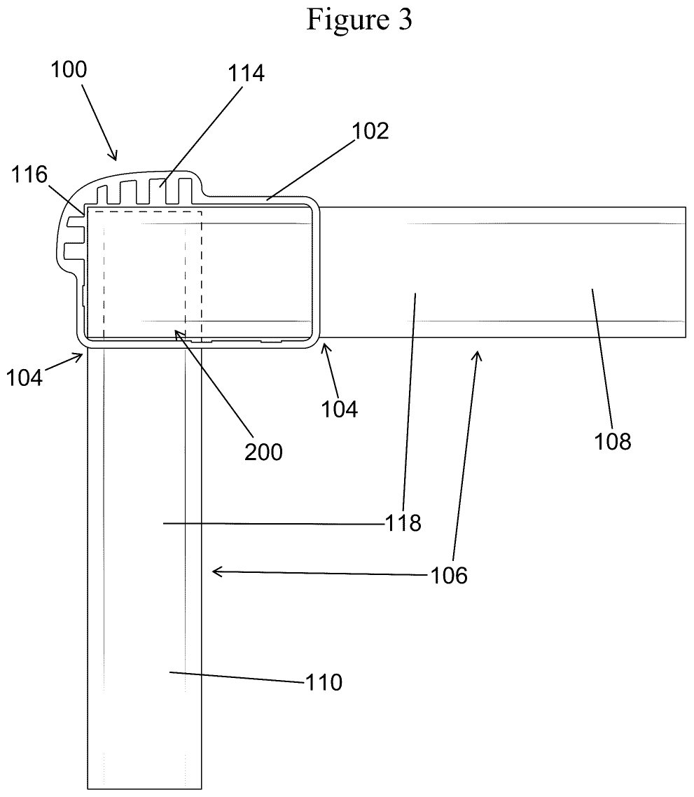

FIG. 3 is a top view of a device for the assembly of components, in accordance with an embodiment of the invention. In some embodiments, the invention is comprised of a device 100 for the assembly of components comprising: a receiver joint 102 wherein the receiver joint 102 is comprised of at least two apertures 104 configured to receive at least one type of extrusion; and at least two types of extrusions 106, a receiver extrusion 108 and an insertion extrusion 110, wherein the receiver extrusion 108 has a channel 200 cut into at least one end of the receiver extrusion 108; and an insertion extrusion 110 wherein the insertion extrusion 110 is shaped to fit into the channel 200 cut into the at least one end of the receiver extrusion 108. In some embodiments, the invention may be further comprised of one or more bonding grooves 114 on an inner surface 116 of the receiver joint 102. For some embodiments, the receiver extrusion 108 and insertion extrusion 110 may be bonded to the receiver joint 102 by welding or similarly bonding around the apertures 104 into which the receiver extrusion 108 and insertion extrusion 110 are inserted such that the aperture 104 is bonded to the outer faces 118 of the receiver extrusion 108 and insertion extrusion 110.

As can be seen in FIG. 3, the receiver extrusion 108 and insertion extrusion 110 are both inserted into appropriate apertures 104 of the receiver joint 102, and the insertion extrusion 110 enters into the channel 200 and/or aperture of the receiver extrusion 108 thereby joining the two. The user can then, if preferred for the embodiment, weld around the apertures 104 of the receiver joint 102 that are in contact with the outer faces 118 of the receiver extrusion 108 and insertion extrusion 110, bonding them to the receiver joint 102. Some variants of the invention may also incorporate a bonding agent inside of the receiver joint 102 to help further adhere the receiver extrusion 108 and insertion extrusion 110. Further, in some embodiments the receiver extrusion 108 and insertion extrusion 110 may be welded together inside the receiver joint 102, or each individually may be welded to the receiver joint 102 internally as inserted, and if needed the receiver joint 102 may have additional apertures 104 or similar orifices and/or ports to facilitate such welding or bonding.

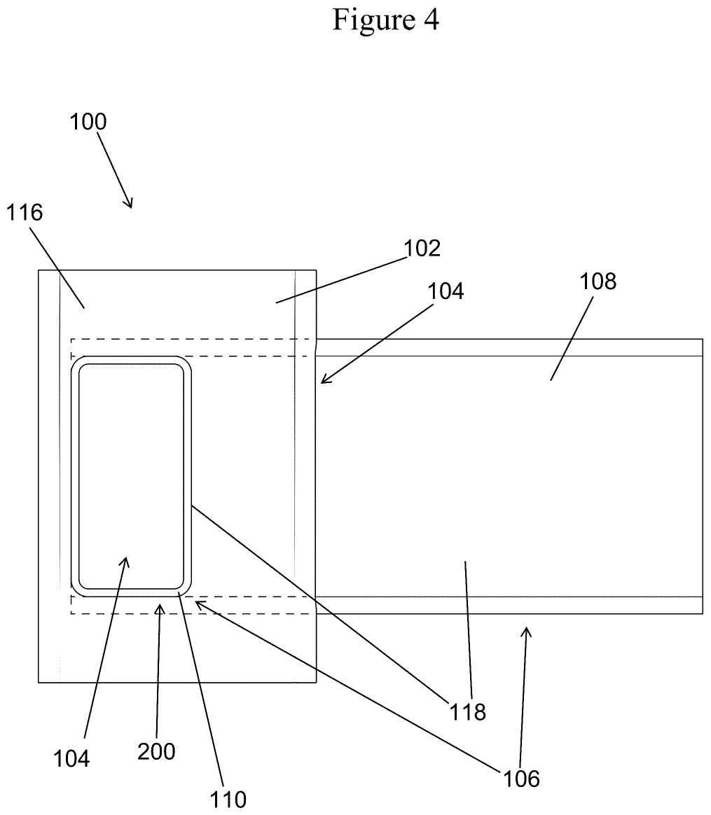

FIG. 4 is a side view of a device for the assembly of components, in accordance with an embodiment of the invention. In some embodiments, the invention is comprised of a device 100 for the assembly of components comprising: a receiver joint 102 wherein the receiver joint 102 is comprised of at least two apertures 104 configured to receive at least one type of extrusion; and at least two types of extrusions 106, a receiver extrusion 108 and an insertion extrusion 110, wherein the receiver extrusion 108 has a channel 200 cut into at least one end of the receiver extrusion 108; and an insertion extrusion 110 wherein the insertion extrusion 110 is shaped to fit into the channel cut into the at least one end of the receiver extrusion 108. In some embodiments, the invention may be further comprised of one or more bonding grooves on an inner surface 116 of the receiver joint 102. For some embodiments, the receiver extrusion 108 and insertion extrusion 110 may be bonded to the receiver joint 102 by welding or similarly bonding around the apertures 104 into which the receiver extrusion 108 and insertion extrusion 110 are inserted such that the aperture 104 is bonded to the outer faces 118 of the receiver extrusion 108 and insertion extrusion 110.

As is demonstrated in in FIG. 4, the receiver extrusion 108 (viewed from the side) and insertion extrusion 110 (viewed down its long axis) are both inserted into appropriate apertures 104 of the receiver joint 102, and the insertion extrusion 110 enters into the channel 200 and/or aperture of the receiver extrusion 108 thereby joining the two. The user can then, if preferred for the embodiment, weld around the apertures 104 of the receiver joint 102 that are in contact with the outer faces of the receiver extrusion 108 and insertion extrusion 110, bonding them to the receiver joint 102. Some variants of the invention may also incorporate a bonding agent inside of the receiver joint 102 to help further adhere the receiver extrusion 108 and insertion extrusion 110. Further, in some embodiments the receiver extrusion 108 and insertion extrusion 110 may be welded together inside the receiver joint 102, or each individually may be welded to the receiver joint 102 internally as inserted, and if needed the receiver joint 102 may have additional apertures 104 to facilitate such welding or bonding.

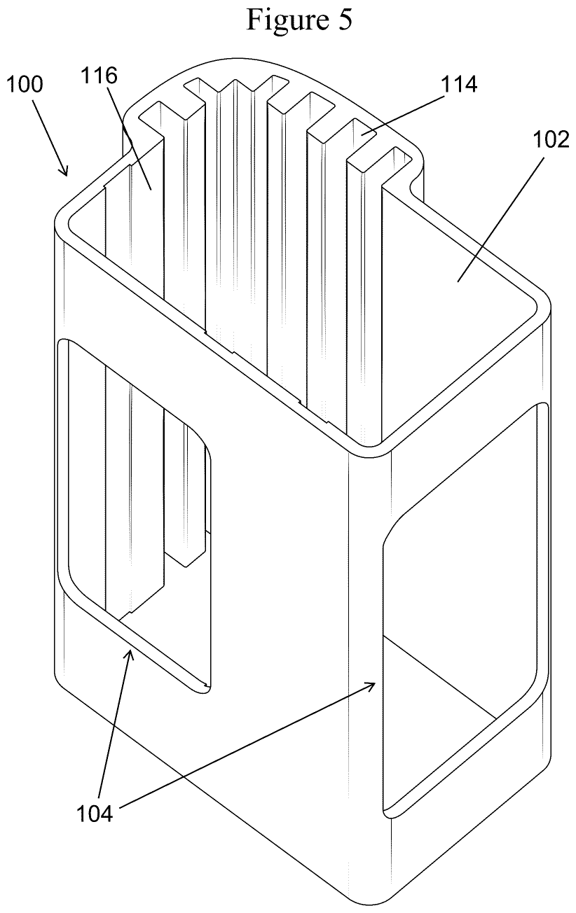

FIG. 5 is a perspective view of a receiver joint component of a device for the assembly of components, in accordance with an embodiment of the invention. In some embodiments, the invention is comprised of a device 100 for the assembly of components comprising: a receiver joint 102 wherein the receiver joint 102 is comprised of at least two apertures 104 configured to receive at least one type of extrusion; and at least two types of extrusions, a receiver extrusion and an insertion extrusion, wherein the receiver extrusion has a channel cut into at least one end of the receiver extrusion; and an insertion extrusion wherein the insertion extrusion is shaped to fit into the channel cut into the at least one end of the receiver extrusion. In some embodiments, the invention may be further comprised of one or more bonding grooves 114 on an inner surface 116 of the receiver joint 102. For some embodiments, the receiver extrusion and insertion extrusion may be bonded to the receiver joint 102 by welding or similarly bonding around the apertures 104 into which the receiver extrusion and insertion extrusion are inserted such that the aperture 104 is bonded to the outer faces of the receiver extrusion and insertion extrusion.

In some embodiments, the receiver joint 102 is a substantially hollow component with at least one aperture 104; configured to receive at least one of an insertion extrusion or a receiver extrusion, though in some embodiments it may have additional apertures 104 for additional extrusions, and may be configured to receive additional sets of receiver extrusions and insertion extrusions, or may be configured to receive an odd number of either type of extrusion. In other embodiments, the receiver joint 102 may be configured to receive an equal number of each type of extrusion. In some embodiments, the receiver joint 102 is configured to have at least one pair of insertion extrusion and receiver extrusion interest inside the hollow interior of the receiver joint 102.

The receiver joint 102 may, depending on the embodiment, be configured with one or more bonding grooves 114 on one or more inner surface 116 of the receiver joint 102, wherein the grooves are configured to create additional surface area for a bonding agent to adhere to the receiver joint 102, and thereby improving the ability of the receiver joint 102 to hold an extrusion that is inserted therein. Some examples of the receiver joint 102 may have the bonding grooves 114 positioned such that they will be in contact with or nearly in contact with an extrusion that is inserted into the aperture of the receiver joint 102, and in the latter case the bonding agent will fill the gap between the bonding groove 114 and extrusion. The bonding grooves 114 may run perpendicular to a long-axis of the extrusions, or may run parallel, or at some other angle as is needed by the embodiment, and may be of a variety of depths which may or may not be uniform in a given embodiment. The bonding grooves 114 may also take the form of stippling, frosting, or other forms of texturing instead of being actual grooves; such as dimples or other irregularities in what would be a flat surface in order to improve surface contact. The bonding grooves 114 may be of a variety of shapes as well, and may curve or bend instead of being straight; for example, some grooves may be triangular in profile, or square, or other irregular polygonal shapes in profile, while they may also curve if needed by the embodiment. Furthermore, the bonding grooves 114 themselves may have textural features to further improve surface contact.

The apertures 104 of the receiver joint 102 may, depending on the needs of the embodiment, be shaped such that they will accommodate the known shape of the receiver extrusion and/or insertion extrusion, such that a user can weld the extrusion to the aperture with little to no gap between them; this design facilitates quick and cost-effective assembly by reducing the need to precisely cut the ends of the receiver extrusion and/or insertion extrusion to fit against the receiver joint 102. In some embodiments, the receiver joint 102 may have additional apertures 104 allowing for the welding together of the receiver extrusion and insertion extrusion once they are inserted, independent of the welds on the apertures 104 of the receiver joint 102.

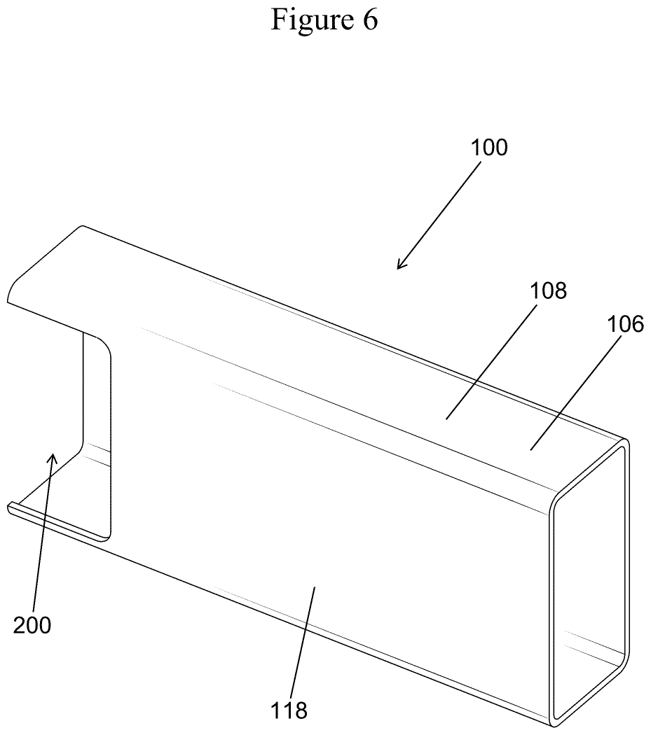

FIG. 6 is a perspective view of a receiver extrusion component of a device for the assembly of components, in accordance with an embodiment of the invention. In some embodiments, the invention is comprised of a device 100 for the assembly of components comprising: a receiver joint wherein the receiver joint is comprised of at least two apertures configured to receive at least one type of extrusion 106; and at least two types of extrusions 106, a receiver extrusion 108 and an insertion extrusion, wherein the receiver extrusion 108 has a channel 200 cut into at least one end of the receiver extrusion 108; and an insertion extrusion wherein the insertion extrusion is shaped to fit into the channel 200 cut into the at least one end of the receiver extrusion 108. In some embodiments, the invention may be further comprised of one or more bonding grooves on an inner surface of the receiver joint. For some embodiments, the receiver extrusion 108 and insertion extrusion may be bonded to the receiver joint by welding or similarly bonding around the apertures into which the receiver extrusion 108 and insertion extrusion are inserted such that the aperture is bonded to the outer faces 118 of the receiver extrusion 108 and insertion extrusion.

Depending on the needs of the embodiment, the receiver extrusion 108 may be configured in a variety of ways. For some embodiments, it will be a substantially hollow shape which may have a variety of polygonal cross-sections, such as, but not limited to, squares, circles, triangles, or other shapes whether regular or irregular in form. The receiver extrusion 108 walls may have a variety of thicknesses depending on the structural needs of the ultimate design. In some embodiments, the extrusions 106 may be substantially tubular in shape, though the cross-section, as mentioned before, may take a variety of shapes and not necessarily need be circular.

For some embodiments of the invention, the receiver extrusion 108 will be configured with a channel 200 and/or aperture at one or more ends, wherein the channel 200 and/or aperture is shaped to match the cross-section of a corresponding insertion extrusion at the angle in which the insertion extrusion will be inserted. For non-exhaustive example, if the insertion extrusion is circular and intended to be inserted perpendicular to the long-axis of the receiver extrusion 108, then the channel 200 and/or aperture will be circular, but if the angle is instead intended to be forty-five degrees relative to the long axis of the receiver extrusion 108, then the channel 200 and/or aperture would need to be ovoid in shape. In cases where the receiver extrusion 108 has multiple channels 200 and/or apertures, they may be located at similar ends or at opposite ends, or somewhere along the length of the receiver extrusion 108. In some embodiments, a receiver extrusion 108 may simultaneously function as a receiver extrusion 108 at one end and an insertion extrusion at the opposite end.

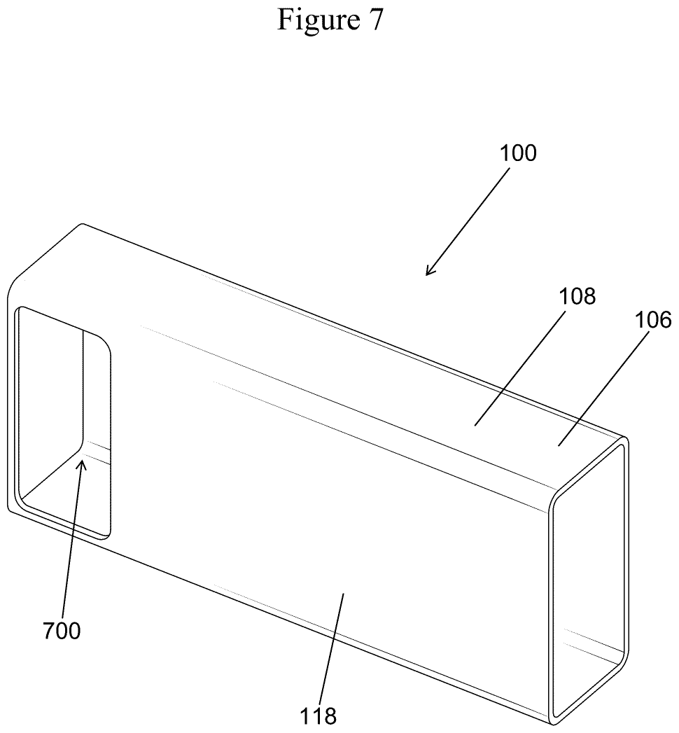

FIG. 7 is a perspective view of a variant of a receiver extrusion component of a device for the assembly of components, in accordance with an embodiment of the invention. In some embodiments, the invention is comprised of a device 100 for the assembly of components comprising: a receiver joint wherein the receiver joint is comprised of at least two apertures configured to receive at least one type of extrusion 106; and at least two types of extrusions 106, a receiver extrusion 108 and an insertion extrusion, wherein the receiver extrusion 108 has a channel or aperture 700 cut into at least one end of the receiver extrusion 108; and an insertion extrusion wherein the insertion extrusion is shaped to fit into the channel or aperture 700 cut into the at least one end of the receiver extrusion 108. In some embodiments, the invention may be further comprised of one or more bonding grooves on an inner surface of the receiver joint. For some embodiments, the receiver extrusion 108 and insertion extrusion may be bonded to the receiver joint by welding or similarly bonding around the apertures into which the receiver extrusion 108 and insertion extrusion are inserted such that the aperture is bonded to the outer faces of the receiver extrusion 108 and insertion extrusion.

For some embodiments of the invention, the receiver extrusion 108 will be configured with a channel and/or aperture at one or more ends, wherein the channel and/or aperture 700 is shaped to match the cross-section of a corresponding insertion extrusion at the angle in which the insertion extrusion will be inserted. For non-exhaustive example, if the insertion extrusion is circular and intended to be inserted perpendicular to the long-axis of the receiver extrusion 108, then the channel and/or aperture 700 will be circular, but if the angle is instead intended to be forty-five degrees relative to the long axis of the receiver extrusion 108, then the channel and/or aperture 700 would need to be ovoid in shape. In cases where the receiver extrusion 108 has multiple channels and/or apertures 700, they may be located at similar ends or at opposite ends, or somewhere along the length of the receiver extrusion 108. In some embodiments, a receiver extrusion 108 may simultaneously function as a receiver extrusion 108 at one end and an insertion extrusion at the opposite end.

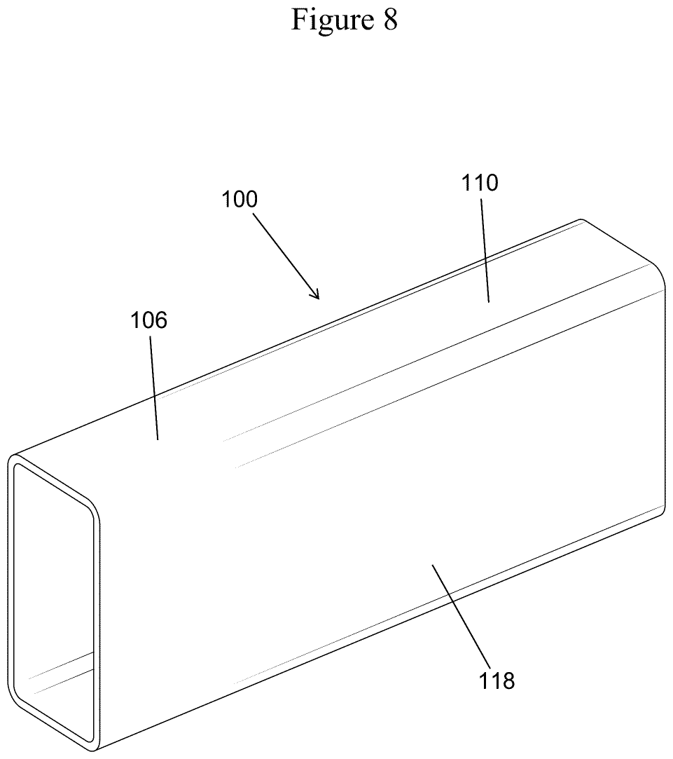

FIG. 8 is a perspective view of an insertion extrusion component of a device for the assembly of components, in accordance with an embodiment of the invention. In some embodiments, the invention is comprised of a device 100 for the assembly of components comprising: a receiver joint wherein the receiver joint is comprised of at least two apertures configured to receive at least one type of extrusion 106; and at least two types of extrusions 106, a receiver extrusion and an insertion extrusion 110, wherein the receiver extrusion has a channel cut into at least one end of the receiver extrusion; and an insertion extrusion 110 wherein the insertion extrusion 110 is shaped to fit into the channel 200 cut into the at least one end of the receiver extrusion. In some embodiments, the invention may be further comprised of one or more bonding grooves on an inner surface of the receiver joint. For some embodiments, the receiver extrusion and insertion extrusion 110 may be bonded to the receiver joint by welding or similarly bonding around the apertures into which the receiver extrusion and insertion extrusion 110 are inserted such that the aperture is bonded to the outer faces of the receiver extrusion and insertion extrusion 110.

In some embodiments, the insertion extrusion 110 is configured to fit into the channel and/or aperture of the receiver extrusion, with its cross-section, or a portion thereof, configured to fit therein. In some embodiments only a portion of the insertion extrusion 110 may be configured such for. For example, the insertion extrusion 110 may flare outward slightly after the portion intended to be inserted into the receiver extrusion and receiver joint, thereby creating a wider profile outward. The same could be done with the receiver extrusion, depending on the embodiment.

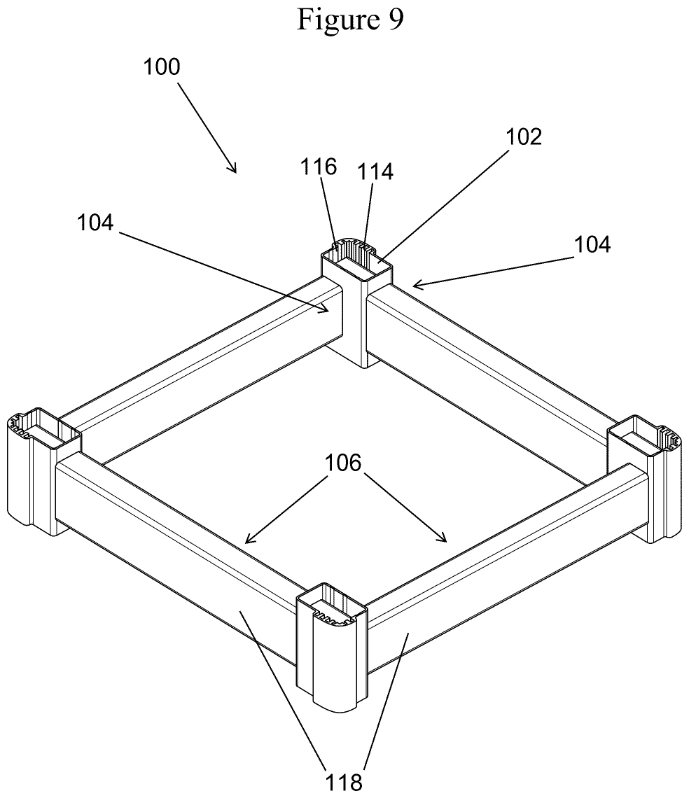

FIG. 9 is a structure assembled using the device for the assembly of components, in accordance with an embodiment of the invention. In some embodiments, the invention is comprised of a device 100 for the assembly of components comprising: a receiver joint 102 wherein the receiver joint 102 is comprised of at least two apertures 104 configured to receive at least one type of extrusion 106; and at least two types of extrusions 106, a receiver extrusion and an insertion extrusion, wherein the receiver extrusion has a channel cut into at least one end of the receiver extrusion; and an insertion extrusion wherein the insertion extrusion is shaped to fit into the channel cut into the at least one end of the receiver extrusion. In some embodiments, the invention may be further comprised of one or more bonding grooves 114 on an inner surface 116 of the receiver joint 102. For some embodiments, the receiver extrusion and insertion extrusion may be bonded to the receiver joint 102 by welding or similarly bonding around the apertures 104 into which the receiver extrusion and insertion extrusion are inserted such that the aperture 104 is bonded to the outer faces 118 of the receiver extrusion and insertion extrusion.

In some embodiments, a plurality of receiver joints 102, receiver extrusions 108, and/or insertion extrusions 110 can be utilized in order to create structures and components thereof. As shown in FIG. 9, four extrusions 106 and four receiver joints 102 create a square shaped component, which could be stacked with additional extrusions, including potentially those going vertically, to create a taller tower structure, or similar structure thereof.

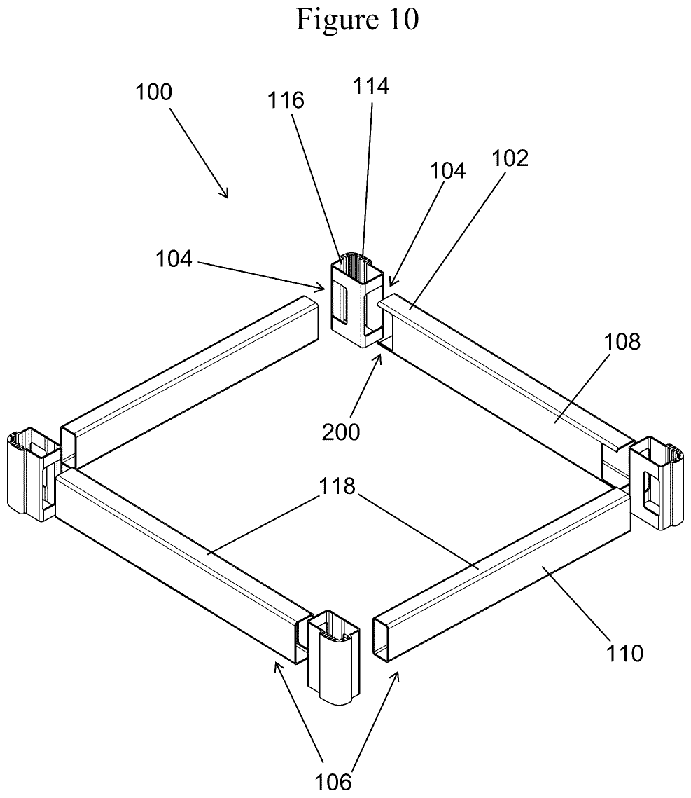

FIG. 10 is an exploded form of a structure assembled using the device for the assembly of components, in accordance with an embodiment of the invention. In some embodiments, the invention is comprised of a device 100 for the assembly of components comprising: a receiver joint 102 wherein the receiver joint 102 is comprised of at least two apertures 104 configured to receive at least one type of extrusion 106; and at least two types of extrusions 106, a receiver extrusion 108 and an insertion extrusion 110, wherein the receiver extrusion 108 has a channel 200 cut into at least one end of the receiver extrusion 108; and an insertion extrusion 110 wherein the insertion extrusion 110 is shaped to fit into the channel 200 cut into the at least one end of the receiver extrusion 108. In some embodiments, the invention may be further comprised of one or more bonding grooves 114 on an inner surface 116 of the receiver joint 102. For some embodiments, the receiver extrusion 108 and insertion extrusion 110 may be bonded to the receiver joint 102 by welding or similarly bonding around the apertures 104 into which the receiver extrusion 108 and insertion extrusion 110 are inserted such that the aperture 104 is bonded to the outer faces 118 of the receiver extrusion 108 and insertion extrusion 110.

In some embodiments, a plurality of receiver joints 102, receiver extrusions 108, and/or insertion extrusions 110 can be utilized in order to create structures and components thereof. As shown in FIG. 10, four extrusions 106 and four receiver joints 102 create a square shaped component, which could be stacked with additional extrusions, including potentially those going vertically, to create a taller tower structure, or similar structure thereof. As is demonstrated in FIG. 10, there may be two receiver extrusions 108 and two insertion extrusions 110, along with four receiver joints 102, wherein the receiver extrusions 108 are inserted into two receiver joints 102 each, and then the insertion extrusions 110 are inserted into the receiver joints 102 and receiver extrusions 108. In FIG. 10, the receiver extrusions 108 each have a channel 200 at each end, while in other embodiments the receiver extrusions 108 may be configured to receive at one end, while might be configured as insertion extrusions 110 at the other, thereby using four identical components as extrusions 106.

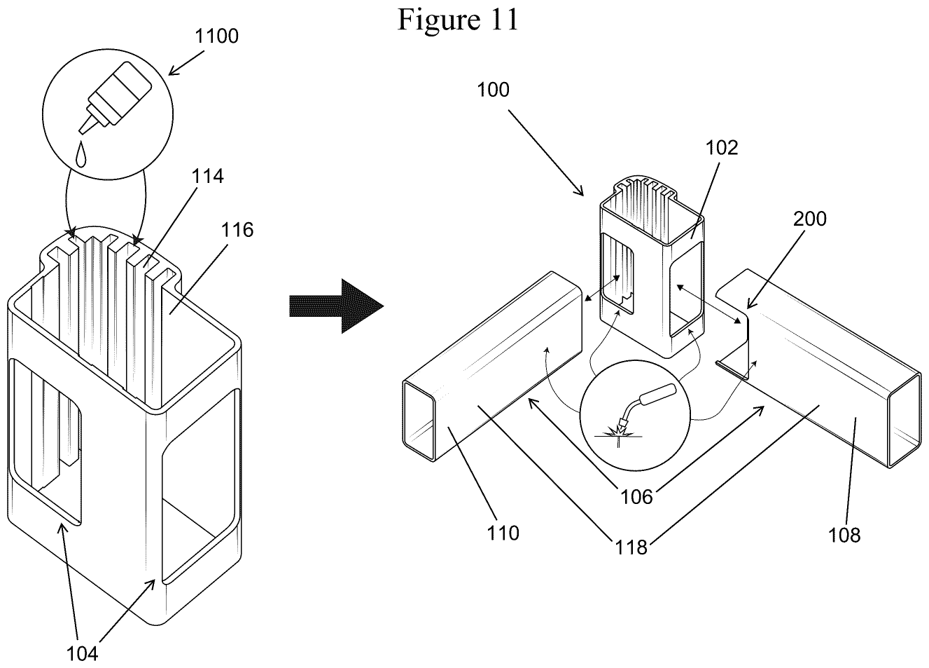

FIG. 11 is a perspective view of the process of assembling a device for the assembly of components, in accordance with an embodiment of the invention. In some embodiments, the invention is comprised of a device 100 for the assembly of components comprising: a receiver joint 102 wherein the receiver joint 102 is comprised of at least two apertures 104 configured to receive at least one type of extrusion; and at least two types of extrusions 106, a receiver extrusion 108 and an insertion extrusion 110, wherein the receiver extrusion 108 has a channel 200 cut into at least one end of the receiver extrusion 108; and an insertion extrusion 110 wherein the insertion extrusion 110 is shaped to fit into the channel 200 cut into the at least one end of the receiver extrusion 108. In some embodiments, the invention may be further comprised of one or more bonding grooves 114 on an inner surface 116 of the receiver joint 102. For some embodiments, the receiver extrusion 108 and insertion extrusion 110 may be bonded to the receiver joint 102 by welding or similarly bonding around the apertures 104 into which the receiver extrusion 108 and insertion extrusion 110 are inserted such that the aperture 104 is bonded to the outer faces 118 of the receiver extrusion 108 and insertion extrusion 110.

The method of assembling the invention is demonstrated in FIG. 11, wherein it is shown that, in some embodiments, first if called for by the embodiment a bonding agent 1100 is inserted into the bonding grooves 114 of the receiver joint 102. Second, the receiver extrusion 108 is inserted into the receiver joint 102, and may, depending on the embodiment, be welded to the receiver joint 102 by welding around the apertures 104 of the receiver joint 102 and by extension the outer face 118 of the receiver extrusion 108. Third, the insertion extrusion 110 is inserted into the receiver joint 102 and receiver extrusion 108, and may, depending on the embodiment, be welded into the receiver joint 102 by welding around the apertures 104 of the receiver joint 102 and by extension the outer face 118 of the insertion extrusion 110. Fourth, if the welding of the extrusions 106 to the receiver joint 102 had not occurred by this stage, then at this stage the receiver extrusion 108 and insertion extrusion 110 would be welded to the receiver joint 102 by welding around the apertures 104 of the receiver joint 102 and by extension also the outer faces 118 of the extrusions 106. The bonding agent 1100, if used in the embodiment, would then cure, further bonding the extrusions 106 to the receiver joint 102. As noted, some embodiments may omit the welding or bonding agent 1100 steps, relying on one or the other method, or some other method, to bind the extrusions 106 to the receiver joint 102.

The bonding agent 1100 can be a variety of substances capable of bonding with the other components of the device. The present invention can also be utilized in addition to traditional welding or similar mechanisms and is not solely limited to replacing the welding component. For example, if ensuring a solid joining of parts is critical, the bonding agent 110 method disclosed herein could be utilized to secure the surfaces of two components together, and then the components could be welded together to form a secondary bond. Some examples of bonding agents 110 that can be used include bonding agents 1100 that involve the combination of two or more chemicals that cure when mixed; while other embodiments of the invention might use single chemical bonding agents 1100. The exact bonding agent 1100 can vary, including, but not limited to, combinations of chemicals, glues, epoxies, resins, cyanoacrylates, latex emulsions, or other forms of bonding agent. In some embodiments, combinations of agents may be used.

In some embodiments, the bonding agent 1100 is applied by applying it to the inner surface 116 of the receiver joint 102 prior to, during, or after the extrusions 106 are inserted, however in other embodiments a hole or similar opening may be drilled or otherwise bored into the receiver joint 102 in order to insert the bonding agent 1100 from an alternative direction. In other embodiments, the bonding agent 1100 may be injected from a top or bottom of the receiver joint 102 such that it is perpendicular to the extrusions 106.

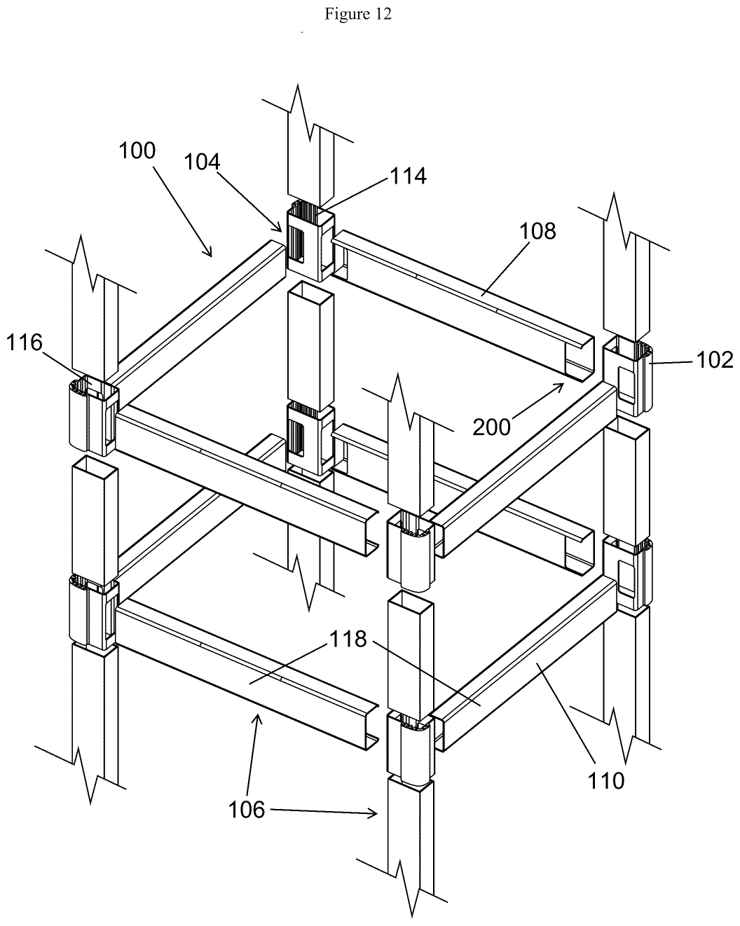

FIG. 12 is a perspective view of a structure assembled using the device for the assembly of components, in accordance with an embodiment of the invention. In some embodiments, the invention is comprised of a device 100 for the assembly of components comprising: a receiver joint 102 wherein the receiver joint 102 is comprised of at least two apertures 104 configured to receive at least one type of extrusion; and at least two types of extrusions 106, a receiver extrusion 108 and an insertion extrusion 110, wherein the receiver extrusion 108 has a channel 200 cut into at least one end of the receiver extrusion 108; and an insertion extrusion 110 wherein the insertion extrusion 110 is shaped to fit into the channel 200 cut into the at least one end of the receiver extrusion 108. In some embodiments, the invention may be further comprised of one or more bonding grooves 114 on an inner surface 116 of the receiver joint 102. For some embodiments, the receiver extrusion 108 and insertion extrusion 110 may be bonded to the receiver joint 102 by welding or similarly bonding around the apertures 104 into which the receiver extrusion 108 and insertion extrusion 110 are inserted such that the aperture 104 is bonded to the outer faces 118 of the receiver extrusion 108 and insertion extrusion 110. In some embodiments, additional extrusions 106 may be utilized to create verticality or add layers when combined with other sets of receiver joints 102, receiver extrusions 108, and/or insertion extrusions 110. Such extrusions 106 may be receiver extrusions 108 and/or insertion extrusions 110, or may be a separate variety without the channel 200 and specific geometric needs.

Accordingly, the scope of the invention is not limited by the disclosure of these preferred and alternate embodiments. Instead, the invention should be determined by reference to the claims that follow.

What is claimed is:

1. A device for the assembly of components, the device comprising:
a receiver joint wherein the receiver joint is comprised of at least two apertures configured to receive at least one type of extrusion; and
at least two types of extrusions, a receiver extrusion and an insertion extrusion, wherein;
the receiver extrusion has a channel cut into at least one end of the receiver extrusion; and
the insertion extrusion is shaped to fit into the channel cut into the at least one end of the receiver extrusion.

2. The device of claim 1, wherein the receiver extrusion is inserted into one of the at least two apertures of the receiver joint and the insertion extrusion is inserted into one of the at least two apertures of the receiver joint such that the insertion extrusion is also inserted into the channel of the receiver extrusion.

3. The device of claim 2, wherein the receiver extrusion and insertion extrusion are bonded to the receiver joint.

4. The device of claim 3, wherein the receiver extrusion and insertion extrusion are bonded to the receiver joint by welding around the at least two apertures of the receiver joint such that an external face of each of the receiver extrusion and insertion extrusion are welded to their corresponding aperture of the receiver joint.

5. The device of claim 2, wherein the receiver joint is comprised of at least one bonding groove on an internal face of the receiver joint.

6. The device of claim 5, wherein a bonding agent is applied to the at least one bonding groove prior to the insertion of the receiver extrusion and insertion extrusion into the at least two apertures of the receiver joint and the bonding agent is in contact with an external face of the receiver extrusion and an external face of the insertion extrusion.

7. The device of claim 1, wherein the receiver extrusion and insertion extrusion are configured to be substantially tubular in shape.

8. The device of claim 1, wherein the receiver joint, receiver extrusion, and insertion extrusion are comprised of extruded aluminum.

9. The device of claim 1, wherein the receiver extrusion and insertion extrusion are instead the ends of a component extrusion and the component extrusion may have either a receiver extrusion end or an insertion extrusion end.

10. The device of claim 5, wherein the receiver joint is further comprised of at least one injection orifice on an outer face configured to receive the bonding agent and channel the bonding agent into the bonding grooves.

11. A method for the assembly of components, the method comprising:
forming a receiver joint wherein the receiver joint is comprised of at least two apertures where each of the at least two apertures is configured to receive at least one type of extrusion and extrusions inserted into each of the at least two apertures would intersect at some point inside the at least two apertures;
forming a receiver extrusion;
cutting a channel into at least one end of the receiver extrusion;
forming an insertion extrusion shaped to fit into the channel of the receiver extrusion;
inserting the receiver extrusion into an aperture of the receiver joint; and
inserting the insertion extrusion into an aperture of the receiver joint such that it also inserts into the channel of the receiver extrusion.

12. The method of claim 11, wherein the method further comprises the steps of:
bonding the receiver extrusion to the receiver joint at the aperture of the receiver joint it has been inserted into; and
bonding the insertion extrusion to the receiver joint at the aperture of the receiver joint it has been inserted into.

13. The method of claim 11, wherein the forming a receiver joint step of the method further comprises: forming one or more bonding grooves onto an inner face of the receiver joint.

14. The method of claim 11, wherein the method further comprises the step of: injecting a bonding agent inside the receiver joint into the one or more bonding grooves of the inner face of the receiver joint.

15. The method of claim 11, wherein the method further comprises the step of: bonding the receiver extrusion and insertion extrusion at a point of contact of the insertion extrusions and the channel of the receiver extrusion.

16. The method of claim 13, wherein the forming a receiver joint step of the method further comprises: applying a texture to the one or more bonding grooves.

17. The method of claim 11, wherein the inserting the receiver extrusion into an aperture of the receiver joint step further comprises: welding the receiver extrusion into the receiver joint.

18. The method of claim 11, wherein the formed components are all formed substantially of aluminum.

19. The method of claim 11, wherein the cutting a channel into at least one end of the receiver extrusion step is instead replaced with the step of cutting an aperture into at least one end of the receiver extrusion.

20. A device for the assembly of components, the device comprising:
a receiver joint wherein the receiver joint is comprised of at least two apertures configured to receive at least one type of extrusion, and one or more bonding grooves on an inner face of the receiver joint; and
at least two types of extrusions, a receiver extrusion and an insertion extrusion, wherein;
the receiver extrusion has a channel cut into at least one end of the receiver extrusion; and
the insertion extrusion is shaped to fit into the channel cut into the at least one end of the receiver extrusion,
and the receiver extrusion and insertion extrusion are inserted into the at least two apertures of the receiver joint and then the receiver extrusion and insertion extrusion are welded into the receiver joint by welding around the least two apertures of the receiver joint and by extension an outward face of the receiver extrusion and insertion extrusion.
